(19) United States
(12) Patent Application Publication
(10) Pub. No.: US 2026/0070821 A1
(43) Pub. Date: Mar. 12, 2026

(54) Nanobubbles for Recovering Metallic Constituents from an Aqueous Stream

(71) Applicant: Messer Industries USA, Inc., Bridgewater, NJ (US)

(72) Inventor: Claire Schmit, Golden, CO (US)

(73) Assignee: Messer Industries USA, Inc., Bridgewater, NJ (US)

(21) Appl. No.: 19/309,712

(22) Filed: Aug. 26, 2025

Related U.S. Application Data
(60) Provisional application No. 63/692,206, filed on Sep. 9, 2024.

(51) Int. Cl. C02F 1/72; C02F 1/52; C02F 1/66; C02F 101/20; C02F 103/10

(52) U.S. Cl. CPC C02F 1/727; C02F 1/5236; C02F 1/66; C02F 2101/20; C02F 2103/10; C02F 2305/02

(57) ABSTRACT

A process of recovering at least one dissolved metal from metals laden water is provided which includes introducing oxygen nanobubbles into the metals laden water, wherein each nanobubble is a size in a range of from 1 nanometer to 900 nanometers; oxidizing the at least one dissolved metal with the oxygen nanobubbles; and precipitating out oxidized metal from the metals laden water for recovering a treated liquid stream and metal particulate. The metals laden water may be for example acid-mine drainage, process streams and wastewaters generated from mining and metals refining operations, process streams and wastewaters generated from metals recycling streams and any other process stream or wastewater generated by an industrial or naturally-occurring process in which metals are dissolved into water.

### BACKGROUND OF THE INVENTION

The present embodiments relate to the use of gases, and compositions which include gases, including but not limited to oxygen, to facilitate recovery of dissolved metals from industrial process streams, wastewaters, and naturally occurring streams laden with metals.

Industrial process streams and wastewaters may include acid-mine drainage, process streams and wastewaters generated from mining and metals refining operations, process streams and wastewaters generated from metals recycling streams, and any other process stream or wastewater generated by an industrial process in which metals are dissolved into water.

For example, the United States currently has more than 30,000 tailings ponds, each of which store water contaminated with various metals. Such metals pose an environmental threat to surrounding communities, but also present an opportunity for resource recovery. Similarly, in the United States and abroad, electronics and battery recycling industries are further developing and are expected to generate wastewater streams with similar characteristics and the potential for adverse impacts upon communities and the landscape.

Naturally occurring streams include permafrost melt and other runoff that have absorbed metals from soil, rock, abandoned mine sites, and other substrate.

For purposes herein, “metals laden water” refers to all potential process streams, wastewaters, and naturally occurring streams unless otherwise specified.

Metals laden water is characterized by the presence of one or more metal elements dissolved into the liquid phase. These metals are present in concentrations that exceed limits considered safe for discharge directly into the environment. The metals must be removed from the liquid phase in an amount sufficient to render the treated water compliant with environmental limits stipulated by law or agency regulations.

For example, acid-mine drainage (AMD) may contain dissolved concentrations of metals such as iron, aluminum, manganese, copper, zinc, arsenic, cadmium, and/or lead depending on the geology of and near the AMD source. The total dissolved species (TDS) concentration in AMD can vary from 2000 mg/L to in excess of 20,000 mg/L.

Known or traditional methods to treat metals laden water are usually selected to meet discharge standards for the treated water, rather than to isolate specific metals from the water for recovery. Typically, water is filtered and subjected to basicity (pH) adjustment using a caustic reagent that causes all metals in solution, i.e., in the water, to precipitate in an agglomeration of metal compounds. Separation of any particular commodity metal from the agglomeration is difficult to economically achieve.

Some metals, due to their individual solubility characteristics can be oxidized and precipitated separately from the other metals at lower pH values. Historically, ozone, peroxide or other chemical oxidants have been used for this purpose. Ozone is effective but requires high capital investment for the ozone generator(s) and significant operating costs associated with the oxygen and electrical needs, as well as continual maintenance. Use of peroxide results in high operating expenses to cover the purchase of the chemical additive(s). Further, the metal oxide solids derived by either of the ozone or peroxide applications tend to form in such a way that traditional dewatering mechanisms, such as gravity settling and filtration, are difficult without the use of oversized equipment and/or additional chemical additives that negatively impact product quality.

Use of pure oxygen, instead of ozone or peroxide, to oxidize the dissolved metals has not been successful when the oxygen is supplied to the system as micro-bubbles having a diameter between 1 and 999 microns. Microbubbles are too buoyant and too large to facilitate sufficient dissolution of the oxygen to react with the dissolved metals in the solution. However, oxygen nanobubbles in which the oxygen gas bubbles have a diameter less than 1 micron have been shown empirically to exhibit more reactive behavior than larger microbubbles.

### SUMMARY OF THE INVENTION

According to an illustrative embodiment of the present invention, provided is a process of recovering at least one dissolved metal from metals laden water, which includes introducing oxygen nanobubbles into the metals laden water, wherein each nanobubble is a size in a range of from 1 nanometer to 900 nanometers; oxidizing the at least one dissolved metal with the oxygen nanobubbles; and precipitating out oxidized metal from the metals laden water for recovering a treated liquid stream and metal particulate.

According to an illustrative embodiment of the present invention, provided is a process of recovering one or more dissolved metals from metals laden water, which includes introducing oxygen nanobubbles indirectly into the metals laden water via recycling a portion of the treated water, wherein each nanobubble is of a size in a range of from 1 nanometer to 900 nanometers; oxidizing the dissolved metal with the oxygen nanobubbles, precipitating the metal oxide from the liquid; recovering a treated liquid stream and recovering the metal particulate in a product slurry.

According to another illustrative embodiment of the present invention there is provided a process of recovering at least one type of metal from a metals laden water, which includes introducing nanobubbles into the metals laden water, wherein each nanobubble is selected from the group consisting of oxygen nanobubbles, nitrogen nanobubbles, carbon dioxide nanobubbles, and mixtures thereof, is a size in a range of from 1 nanometer to 900 nanometers.

According to another illustrative embodiment of the present invention, provided is a process to treat dewatering characteristics of metals recovered from a solution, which includes mixing nanobubbles of gas into the metals laden water solution, wherein each nanobubble in the mixing is a size in a range or from 1 nanometer to 900 nanometers for improving at least one of a precipitation rate of the metals out of the solution, and a filterability of the metals from the solution.

According to still another illustrative embodiment of the present invention, the nanobubbles of gas used to treat dewatering characteristics of metals recovered from a solution will primarily be oxygen (O₂) but may also be selected from the group consisting of, but not limited to, carbon dioxide (CO₂) nanobubbles, nitrogen (N₂) nanobubbles, and mixtures thereof.

Nanobubbles, each of which measure less than 900 nanometers (nm) in diameter, are one of the smallest known bubble sizes. Nanobubbles can remain suspended in liquid for many weeks without rising to the surface and off-gassing to atmosphere, unlike known larger bubble size, i.e., microbubbles. This is because nanobubbles are significantly smaller by several orders of magnitude than microbubbles. Nanobubbles with a diameter each in the range of 70-120 nm are 1000 times smaller than microbubbles used in other gas addition processes.

Because nanobubbles have a smaller ratio of surface area to volume (surface area: volume) in solution, and because nanobubbles remain suspended in liquid for a longer duration of time than larger bubbles, it is possible to provide a greater concentration of gas into a liquid using nanobubbles than can be done with other gas methods.

Nanobubbles exhibit different physical and chemical properties compared to larger scale bubbles of the same gas in solution or dissolved gases. Nanobubbles may exhibit different physical and chemical properties at the gas/liquid interface in the liquid, and each nanobubble or a myriad of nanobubbles may exhibit a small electrical charge at their surface or surfaces.

The benefits of the claimed embodiments using the nanobubble treatments include, but are not limited to, cost effective oxidation and recovery of dissolved metals, improved product quality of the recovered metals, and/or improved dewatering properties of the recovered metals.

### BRIEF DESCRIPTION OF THE DRAWINGS

For a more complete understanding of the present embodiments, reference may be had to the following description of exemplary embodiments considered in connection with the accompanying drawing Figures, of which:

FIG. 1 shows an apparatus for providing a process to recover metals from metals laden water or a solution with direct application of nanobubbles according to an embodiment of the present invention.

FIG. 1A shows a caustic reagent embodiment for use with the embodiment of FIG. 1.

FIG. 2 shows an apparatus for providing a process to recover metals from metals laden water or a solution with in-direct application of nanobubbles according to another embodiment of the present invention.

FIG. 2A shows a caustic reagent embodiment for use with the embodiment of FIG. 2.

FIG. 3 shows an apparatus for providing a process to recover metals from metals laden water or a solution with direct and in-direct application of nanobubbles according to still another embodiment of the present invention.

FIG. 3A shows a caustic reagent embodiment for use with the embodiment of FIG. 3.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

As used in this specification, the terms “comprises”, “contains”, “containing”, “comprising”, “includes”, “including”, “has”, or “having”, are open-ended expressions and are intended to cover methods, processes, products, apparatus, or systems that comprise a recited list of components, elements, and features, and any and all additional components, elements and features that are not expressly recited.

The term “introduced” and any variants as used herein refer to and include “to mix in”, “to provide to”, to inject into”, “to introduce into, and “to deliver to”. It is to be understood that as used and described herein the process embodiments can facilitate recovery of dissolved metals in metals laden water and in an aqueous stream.

Treating liquids with nanobubbles of oxygen, each nanobubble of which ranges in size from a few nanometers to a few hundred nanometers in diameter, provides oxygen bubbles with unique properties. For example, oxygen nanobubbles, due to their small size and large surface area, can significantly increase the interfacial area between the gas phase and liquid phase. This increased surface area facilitates enhanced mass transfer phenomena, such as improved gas dissolution or extraction of dissolved substances from the liquid.

The present embodiments call for the use of nanobubbles of gas, particularly but not limited to oxygen, to facilitate precipitation and recovery of dissolved metals present in industrial process streams and wastewaters, as well as in naturally occurring metals laden waters.

The present embodiments also call for the use of nanobubbles of gas, particularly but not limited to oxygen, to improve the dewatering properties of the metals recovered from metals laden water.

Streams to be treated with the nanobubbles include but are not limited to acid-mine drainage, process streams and wastewaters generated from mining and metals refining operations, process streams and wastewaters generated from metals recycling streams and any other process stream, wastewater generated by an industrial process, or naturally occurring streams in which metals are dissolved into water.

The physical properties of oxygen nanobubbles render such nanobubbles more readily reactive than larger microbubbles of oxygen for use as an oxidant of dissolved metals. As oxygen nanobubbles encounter dissolved metal ion(s), oxidation reactions occur. The newly oxidized forms of the metals are much less soluble in water and will precipitate out as fine particulate. The particulate can be recovered from the water in subsequent dewatering and filtration steps, processed as needed, and sold as commodity material. Use of oxygen nanobubbles in this manner is more economical and requires less maintenance than use of other chemical oxidants for the same purpose.

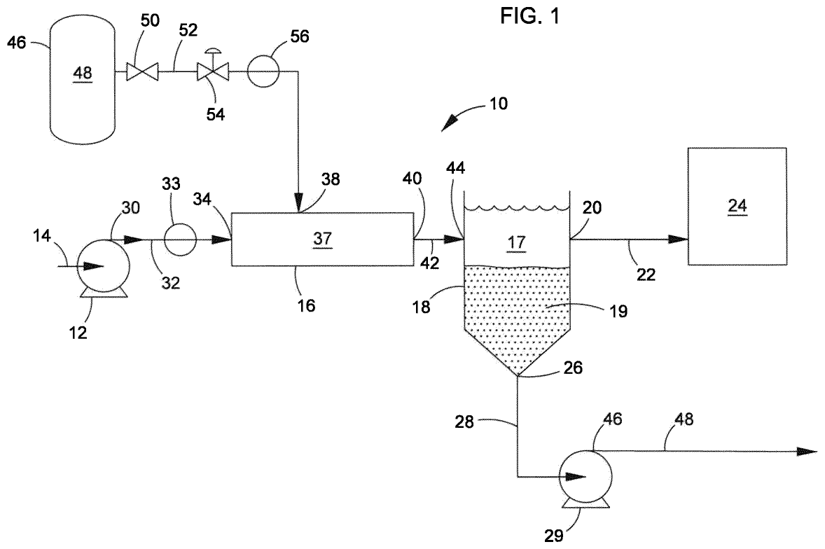

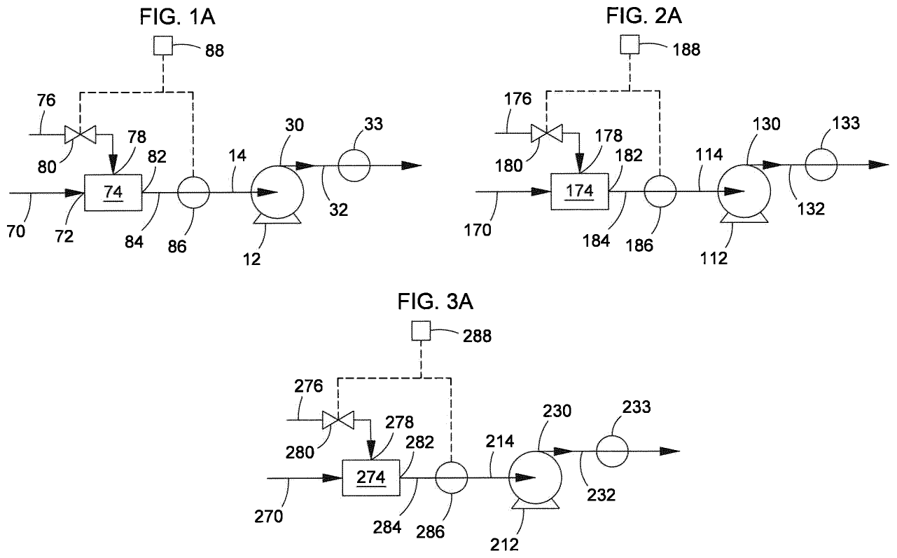

Referring to the Figures, FIG. 1 shows an apparatus 10 embodiment of the present invention for direct introduction of nanobubbles, such as for example oxygen nanobubbles, into a metals laden water, such as results from an acid-mine drainage stream. The apparatus 10 includes a pump 12 to transfer metals laden water 14 (also known as (a/k/a) a “target stream”), a nanobubble generator 16, and an oxidation tank 18 or vessel in which oxidation reactions occur in the metals laden water, such as for example acid mine drainage.

An outlet 30 of the pump 12 is in fluid connection with an end of another pipe 32 or conduit, while an opposite end of the pipe 32 is connected to a first inlet 34 of a nanobubble generator 16. A flowmeter 33 is interposed in the pipe 32. The nanobubble generator 16 includes a second inlet 38 for a purpose to be described below, and an outlet 40 in fluid connection with an end of a pipe 42 or conduit. An opposite end of the pipe 42 is in fluid connection with an inlet 44 to the oxidation tank 18.

A gas cylinder 46 or vessel contains a gas 48 therein, and such gas is used in the production of the nanobubbles in the nanobubble generator 16. Such gas can be for example oxygen. In that regard, the gas cylinder 46 includes a valve 50 through which the gas 48 can be released from the gas cylinder into a pipe 52 in fluid connection with the valve. A regulator 54 and a flow meter 56 are interposed in the pipe 52. An end of the pipe 52 opposite to the end connected with the valve 50 is in fluid connection with the second inlet 38 of the nanobubble generator 16. An oxygen stream from the gas 48 flows through the pipe 52 into the nanobubble generator 16.

In operation, the pump 12 transfers the untreated, metals laden water 14 or the target stream through the pipe 32 at a desired flow rate and discharge pressure through the first inlet 34 into the nanobubble generator 16. The gas 48 from the gas cylinder 46 is metered and pressurized for transit through the pipe 52 and the inlet 38 into the nanobubble generator 16, so that an optimum volume of the gas 48 becomes nanobubbles in the nanobubble generator for introduction into the metals laden water 14 provided to the nanobubble generator. A concentration of nanobubbles 37 provided from the nanobubble generator 16 into the metals laden water 14 is determined by the gas flow rate, the untreated water flow rate, and number of nanobubble generators in operation. A nanobubble-oxygenated stream of the target stream flows from the nanobubble generator 16 through the pipe 42 into the oxidation tank 18.

The nanobubbles 37 oxidize the metallic constituents in the target stream 14 which forms metallic solids that precipitate out of the target stream. The treated water 17 in the oxidation tank 18 will overflow via an outlet 20 to which an end of a pipe 22 or conduit is connected for fluid communication to a storage tank 24. The metals or the metallic solids in the oxygenated stream precipitate out into a slurry 19 contained in the oxidation tank 18 as a result of exposure to the nanobubbles. A separate connection 26 at a bottom of the oxidation tank 18 allows for gravity discharge of the product slurry 19 through a conduit 28 in fluid connection with a pump 29. The pump 29 is provided with an outlet 46 to transfer the product slurry 19 through a pipe 48 or conduit for further processing.

The dissolved oxygen concentration of the untreated water flowing through the conduit 32, and the treated water overflowing from the oxidation tank 18 and flowing through the pipe 22 are measured continuously. Pump flow at the pumps 12, 29 will be adjusted to maintain a desired dissolved oxygen concentration in the treated water collected in the storage tank 24.

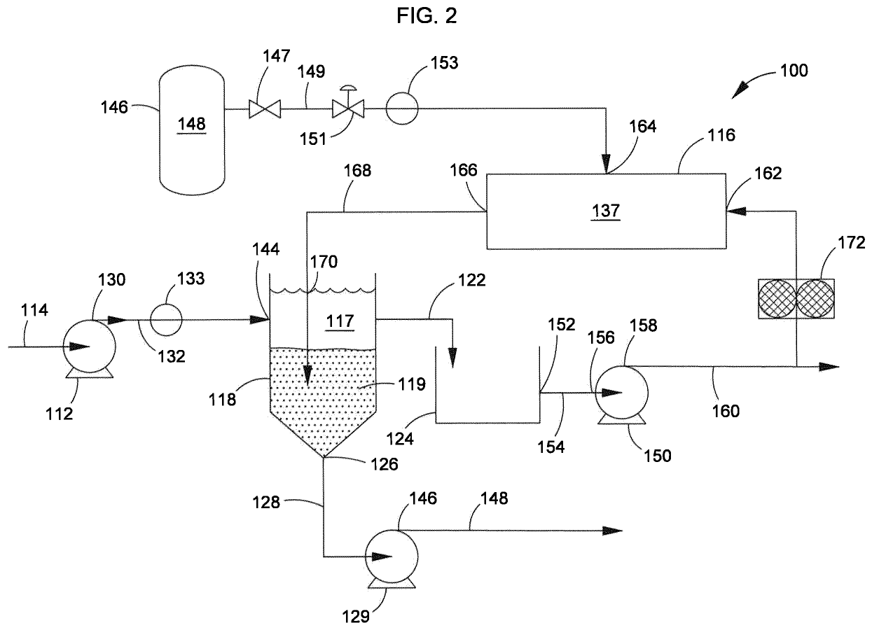

Referring now to FIG. 2, presented is an apparatus 100 embodiment of the present invention for in-direct introduction of nanobubbles, such as for example oxygen nanobubbles, into a metals laden water, such as an acid-mine drainage stream. The apparatus 100 includes a pump 112 to transfer metals laden water 114 (also known as (a/k/a) a “target stream”), an oxidation tank 118 or vessel in which the oxidation reactions will occur in the metals laden water, an overflow tank 124 or storage tank to collect treated water 117, a nanobubble generator 116, and a pump 150 to transfer the treated water from the tank 124.

An outlet 130 of the pump 112 is in fluid connection with an end of another pipe 132 or conduit, while an opposite end of the pipe 132 is connected to an inlet 144 of the oxidation tank 118. A flowmeter 133 is interposed in the pipe 132.

An outlet 152 of the treated water storage tank 124 is in fluid connection with an end of another pipe 154 or conduit, while an opposite end of the pipe 154 is connected to an inlet 156 of a treated water pump 150. An outlet 158 of the treated water pump 150 is in fluid connection with an end of another pipe 160 or conduit, while an opposite end of the pipe 160 is connected to a first inlet 162 of the nanobubble generator 116. The nanobubble generator 116 includes a second inlet 164 for a purpose to be described below, and an outlet 166 in fluid connection with an end of a pipe 168 or conduit. An opposite end of the pipe 168 is in fluid connection with an inlet 170 to the oxidation tank 118.

A gas cylinder 146 or vessel contains a gas 148 therein, which gas may be for example oxygen, and such gas is used in the production of the nanobubbles in the nanobubble generator 116. In that regard, the gas cylinder 146 includes a valve 147 through which the gas 148 can be released from the cylinder into a pipe 149 in fluid connection with the valve. A regulator 151 and a flow meter 153 are interposed in the pipe 149. An end of the pipe 149 opposite to the end connected with the valve 147 is in fluid connection with the second inlet 164 of the nanobubble generator 116. The gas 148 is provided as an oxygen stream to the nanobubble generator 116.

In operation, the pump 112 transfers the untreated, metals laden water 114 or the target stream through the pipe 132 at a desired flow rate and discharge pressure through the inlet 144 into the oxidation tank 118. The treated water 117 can overflow the oxidation tank 118 via a pipe 122 or conduit into the treated water storage tank 124. The treated water pump 150 transfers a portion of the treated water 117 from the treated water storage tank 124 through the outlet 152 and through the pipe 154 at a desired flow rate and discharge pressure into the pipe 160. A portion of the treated water 117 is filtered through a filter apparatus 172, such as for example a duplex-style filter, and then conveyed to the nanobubble generator 116. The gas 148 from the gas cylinder 146 is metered and pressurized for transit as an oxygen stream through the pipe 149 and the inlet 164 into the nanobubble generator 116, so that an optimum volume of gas 148 becomes nanobubbles in the generator 116 for introduction into the treated water 117 provided to the nanobubble generator from the first inlet 162. A nanobubble-oxygenated stream of the treated water flows from the nanobubble generator 116 through the pipe 168 into the oxidation tank 118. A concentration of the nanobubbles 137 provided from the nanobubble generator 116 into the oxidation tank 118 is determined by the gas flow rate, the treated water flow rate, the untreated water flow rate, and number of nanobubble generators in operation. The nanobubbles 137 oxidize the metallic constituents in the target stream 114 which forms metallic solids that precipitate out of the target stream.

A separate connection 126 at a bottom of the oxidation tank 118 allows for gravity discharge of product slurry 119 through a pipe 128 or conduit to a pump 129. The metals in the oxygenated stream precipitate into the product slurry 119 as a result of exposure to the nanobubbles. The pump 129 is provided with an outlet 146 to transfer the product slurry 119 through a pipe 148 or conduit for further processing.

The at least one filter apparatus 172 and for certain applications a plurality of the filter apparatus, are interposed in the conduit 160 upstream of the inlet 162 to the nanobubble generator 116. The at least one filter apparatus 172 removes contaminants or other particulate matter that may be present in the stream being delivered through the pipe 160 before introduction into the nanobubble generator 116.

The dissolved oxygen concentration of the untreated water 114 or target stream, and the treated water 117 overflowing from the oxidation tank 124 is measured continuously. Pump flow 150 will be adjusted to maintain a desired conductivity measurement in the treated water 117.

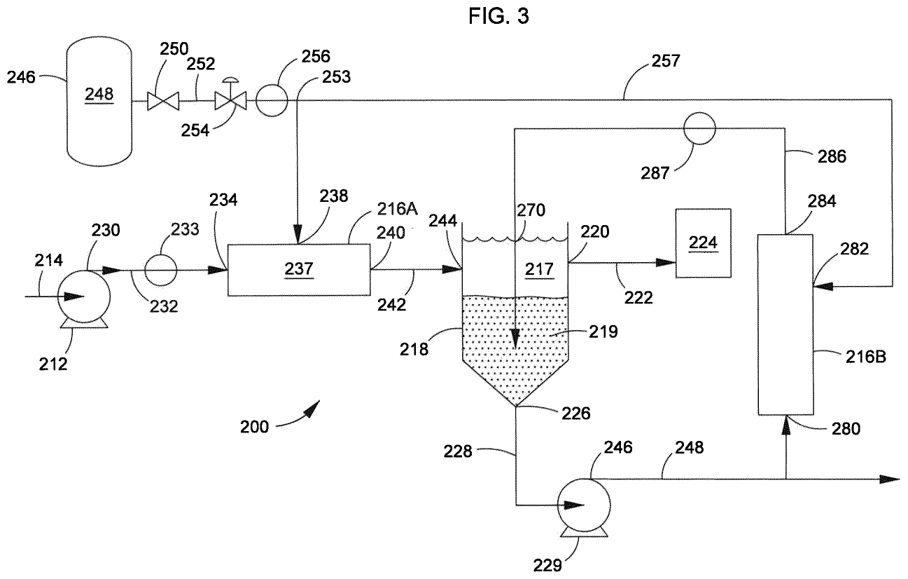

Referring now to FIG. 3, an apparatus 200 embodiment of the present invention is provided for direct introduction of nanobubbles, such as for example oxygen nanobubbles, into a metals laden water, such as for example an acid-mine drainage stream, in addition to introduction of nanobubbles into a recycled nanobubbles stream into the oxidation tank 218. The apparatus 200 includes a pump 212 to transfer metals laden water 214 (the “target stream”), a plurality of nanobubble generators 216A, 216B, an oxidation tank 218 or vessel in which the oxidation reactions will occur in the metals laden water, an overflow tank 224 or storage tank to collect treated water 217, and a product pump 229.

An outlet 230 of the pump 212 is in fluid connection with an end of another pipe 232 or conduit, while an opposite end of the pipe 232 is connected to a first inlet 234 of a nanobubble generator 216A. The nanobubble generator 216A includes a second inlet 238 for a purpose to be described below, and an outlet 240 in fluid connection with an end of a pipe 242 or conduit. An opposite end of the pipe 242 is in fluid connection with an inlet 244 to the oxidation tank 218.

A gas cylinder 246 or vessel contains a gas 248 therein, such as for example oxygen, and such gas is used in the production of the nanobubbles in the nanobubble generators 216A, 216B. In that regard, the gas cylinder 246 includes a valve 250 through which the gas 248 can be released from the cylinder into a pipe 252 in fluid connection with the valve. A regulator 254 and a flow meter 256 are interposed in the pipe 252. An end of the pipe 252 opposite to the end connected with the valve 250 is in fluid connection with the second inlet 238 of the nanobubble generator 216A. The pipe 252 is provided with a T-section or “branched” at 253 at which position another pipe 257 or conduit extends to be in fluid connection with the nanobubble generator 216B as described and for a purpose discussed below.

In operation, the pump 212 transfers the untreated, metals laden water 214 (the “target stream”) through the pipe 232 at a desired flow rate and discharge pressure into the nanobubble generator 216A. The gas 248 from the gas cylinder 246 is metered and pressurized for transit as an oxygen stream through the pipe 252 and the inlet 238 into the nanobubble generator 216A, so that an optimum volume of the gas 248 becomes nanobubbles in the generator 216A for introduction into the metals laden water 214. A concentration of the nanobubbles 237 provided from the generator 216A into the metals laden water 214 in the generator is determined by the gas flow rate, the untreated water flow rate, and number of nanobubble generators in operation. The nanobubbles 237 oxidize the metallic constituents in the target stream 214 which forms metallic solids that precipitate out of the target stream.

Treated water 217 from the oxidation tank 218 will overflow via an outlet 220 to which an end of a pipe 222 or conduit is connected for fluid communication to a storage tank 224. A separate connection 226 at a bottom of the oxidation tank 218 allows for gravity discharge of product slurry 219 through a pipe 228 or conduit to the pump 229.

An outlet 246 of the product pump 229 is in fluid connection with an end of another pipe 248 or conduit, while an opposite end of the pipe 248 is connected to a first inlet 280 of the nanobubble generator 216B. The nanobubble generator 216B includes a second inlet 282 to receive the oxygen stream in the pipe 257 for a purpose described above, and an outlet 284 in fluid connection with an end of a pipe 286 or conduit. A flow meter 287 is interposed in the pipe 286. An opposite end of the pipe 286 is in fluid connection with an inlet 270 to the oxidation tank 218.

In operation, the product pump 229 transfers a portion of the product slurry 219 from the outlet 246 through the pipe 248 at a desired flow rate and discharge pressure into the nanobubble generator 216B. The gas 248 from the gas cylinder 246 is metered and pressurized for transit through the pipes 252, 257 and the inlet 282 into the nanobubble generator 216B, so that an optimum volume of the gas 248 also becomes nanobubbles in the generator 216B for introduction into portion of the product slurry. The oxygenated product slurry is discharged from the outlet 284 into the pipe 286 and into the oxidation tank 218. A concentration of the nanobubbles 257 provided from the generator 216B into the oxidation tank 218 is determined by the gas flow rate, the product slurry flow rate, and number of nanobubble generators in operation. The metals in the oxygenated steam precipitate into the product slurry 219 as a result of exposure to the nanobubbles.

The dissolved oxygen concentration of the untreated water 214 and the treated water 217 overflowing from the oxidation tank 218 is measured continuously. Pump flow is adjusted to maintain the desired dissolved oxygen concentration in the treated water.

The density of the product slurry 219 is measured continuously. Recycle flow back from the nanobubble generator 216B to the oxidation tank 218 is adjusted to maintain target density consistent with the requirements of the process.

The nanobubbles of the gas used in all the embodiments above include oxygen nanobubbles, nitrogen nanobubbles, carbon dioxide nanobubbles, and combination thereof.

Referring now to FIGS. 1A, 2A and 3A, there are provided therein additional embodiments which each introduce a caustic reagent into each of the target streams 14, 114 and 214 for adjusting the pH of the respective target stream in order to facilitate better oxidation of the nanobubbles in the respective nanobubble generators 16, 116 and 216 and oxidation tanks 18, 118 and 218.

Referring now to FIG. 1A, upstream of the pump 12, a raw or natural metals laden water stream 70 or the “raw stream” will be monitored and processed as necessary to result in the target stream 14 to be introduced into the apparatus 10. The raw stream 70 is provided directly or through a pipe or conduit to an inlet 72 of a mixing chamber 74 or vessel. A caustic reagent 76, such as but not limited to sodium hydroxide, calcium hydroxide or another similar caustic reagent for adjusting pH, is provided through a pipe or conduit to another inlet 78 of the mixing chamber 74. A feed valve 80 controls the flow of the caustic reagent 76 through the pipe into the mixing chamber 74. The caustic reagent 76 is introduced into the mixing chamber 74 to adjust the pH of the raw stream 70 to be up to and including 7.0 pH, which is a beneficial range of pH for oxidation to occur in the nanobubble generator 16. An outlet 82 of the mixing chamber 74 is in fluid communication with a pipe or conduit in which flows a pH adjusted water stream 84. A pH probe and meter 86 (collectively, the “probe”) is interposed in the pipe to sense and measure the pH of the pH adjusted water stream 84 flowing through the pipe. A controller 88 or PLC is electrically connected to both the feed valve 80 and the probe 86 to receive signals transmitted from the probe regarding the pH measurement of the pH adjusted water stream 84. If the controller 88 receives a signal that the stream 84 has a pH measurement outside the target pH, the controller will adjust the feed valve 80 accordingly to selectively adjust the flow of the caustic reagent 76 into the mixing chamber 74. Therefore, if the pH measured by the probe 86 differs from the target pH, an amount of the caustic reagent 76 will accordingly be adjusted for introduction into the mixing chamber 74. If and when the probe 86 measures the pH to be at the target pH, the pH adjusted water stream 84 becomes the target stream 14 for introduction into the pump 12. It should be noted that, generally, the caustic reagent 76 raises the pH level of the raw stream 70 almost instantly so that the target stream 14 with the appropriate pH level being drawn into the pump 12 is ready for subsequent processing in the nanobubble generator 16. In most instances where the raw stream 70 originates from a single place or locality, the pH of the raw stream is consistent and uniform such that after the caustic reagent 76 is introduced to provide the necessary pH level, the rate of introduction of the caustic reagent can remain uniform and to the extent the pH needs to be adjusted, such is done to bring about a relatively rapid change in the pH such that processing of the target stream 14 downstream from the pump 12 does not have to be changed.

Referring to FIG. 2A, upstream of the pump 112, a raw or natural metals laden water stream 170 or the “raw stream” will be monitored and processed as necessary to result in the target stream 114 to be introduced into the apparatus 110. The raw stream 170 is provided directly or through a pipe or conduit to an inlet 172 of a mixing chamber 174 or vessel. A caustic reagent 176, such as but not limited to sodium hydroxide, calcium hydroxide or another similar caustic reagent for adjusting pH, is provided through a pipe or conduit to another inlet 178 of the mixing chamber 174. A feed valve 180 controls the flow of the caustic reagent 176 through the pipe into the mixing chamber 174. The caustic reagent 176 is introduced into the mixing chamber 174 to adjust the pH of the raw stream 170 to be up to and including 7.0 pH, which is a beneficial range of pH for oxidation to occur in the nanobubble generator 116. An outlet 182 of the mixing chamber 174 is in fluid communication with a pipe or conduit in which flows a pH adjusted water stream 184. A pH probe and meter 186 (collectively, the “probe”) is interposed in the pipe to sense and measure the pH of the pH adjusted water stream 184 flowing through the pipe. A controller 188 or PLC is electrically connected to both the feed valve 180 and the probe 186 to receive signals transmitted from the probe regarding the pH measurement of the pH adjusted water stream 184. If the controller 188 receives a signal that the stream 184 has a pH measurement outside the target pH, the controller will adjust the feed valve 180 accordingly to selectively adjust the flow of the caustic reagent 176 into the mixing chamber 174. Therefore, if the pH measured by the probe 186 differs from the target pH, an amount of the caustic reagent 176 will accordingly be adjusted for introduction into the mixing chamber 174. If and when the probe 186 measures the pH to be at the target pH, the pH adjusted water stream 184 becomes the target stream 114 for introduction into the pump 112. It should be noted that, generally, the caustic reagent 176 raises the pH level of the raw stream 170 almost instantly so that the target stream 114 with the appropriate pH level being drawn into the pump 112 is ready for subsequent processing in the nanobubble generator 116. In most instances where the raw stream 170 originates from a single place or locality, the pH of the raw stream is consistent and uniform such that after the caustic reagent 176 is introduced to provide the necessary pH level, the rate of introduction of the caustic reagent can remain uniform and to the extent the pH needs to be adjusted, such is done to bring about a relatively rapid change in the pH such that processing of the target stream 114 downstream from the pump 112 does not have to be changed.

Referring to FIG. 3A, upstream of the pump 212, a raw or natural metals laden water stream 270 or the “raw stream” will be monitored and processed as necessary to result in the target stream 214 to be introduced into the apparatus 210. The raw stream 270 is provided directly or through a pipe or conduit to an inlet 272 of a mixing chamber 274 or vessel. A caustic reagent 276, such as but not limited to sodium hydroxide, calcium hydroxide or another similar caustic reagent for adjusting pH, is provided through a pipe or conduit to another inlet 278 of the mixing chamber 274. A feed valve 280 controls the flow of the caustic reagent 276 through the pipe into the mixing chamber 274. The caustic reagent 276 is introduced into the mixing chamber 274 to adjust the pH of the raw stream 270 to be up to and including 7.0 pH, which is a beneficial range of pH for oxidation to occur in the nanobubble generator 216. An outlet 282 of the mixing chamber 274 is in fluid communication with a pipe or conduit in which flows a pH adjusted water stream 284. A pH probe and meter 286 (collectively, the “probe”) is interposed in the pipe to sense and measure the pH of the pH adjusted water stream 284 flowing through the pipe. A controller 288 or PLC is electrically connected to both the feed valve 280 and the probe 286 to receive signals transmitted from the probe regarding the pH measurement of the pH adjusted water stream 284. If the controller 288 receives a signal that the stream 284 has a pH measurement outside the target pH, the controller will adjust the feed valve 280 accordingly to selectively adjust the flow of the caustic reagent 276 into the mixing chamber 274. Therefore, if the pH measured by the probe 286 differs from the target pH, an amount of the caustic reagent 276 will accordingly be adjusted for introduction into the mixing chamber 274. If and when the probe 286 measures the pH to be at the target pH, the pH adjusted water stream 284 becomes the target stream 214 for introduction into the pump 212. It should be noted that, generally, the caustic reagent 276 raises the pH level of the raw stream 270 almost instantly so that the target stream 214 with the appropriate pH level being drawn into the pump 212 is ready for subsequent processing in the nanobubble generator 216. In most instances where the raw stream 270 originates from a single place or locality, the pH of the raw stream is consistent and uniform such that after the caustic reagent 276 is introduced to provide the necessary pH level, the rate of introduction of the caustic reagent can remain uniform and to the extent the pH needs to be adjusted, such is done to bring about a relatively rapid change in the pH such that processing of the target stream 214 downstream from the pump 212 does not have to be changed.

All of the embodiments called for in FIGS. 1-3 and 1A-3A use nanobubbles 37, 137, 237 to facilitate solid particulate metals to precipitate out of the respective target streams 14, 114, 214.

In view of the foregoing, the present invention includes the following related inventive embodiments (“Emb”), and it is understood that reference to metals laden water, solution, and aqueous stream includes reference to all examples defined herein:

Emb 1. A process of recovering at least one dissolved metal from metals laden water, which includes: introducing oxygen nanobubbles into the metals laden water, wherein each nanobubble is a size in a range of from 1 nanometer to 900 nanometers; oxidizing the at least one dissolved metal with the oxygen nanobubbles; and precipitating out oxidized metal from the metals laden water for recovering a treated liquid stream and metal particulate.

Emb 2. The process of Emb 1, wherein the metals laden water is selected from the group consisting of an industrial process stream, an industrial wastewater stream, a naturally occurring stream, acid-mine drainage, wastewater generated from a mining and metals refining operation, a process stream and wastewater generated from a metals recycling process, and other process streams or wastewaters generated by an industrial process in which metals are dissolved into the process stream and the wastewater.

Emb 3. The process of Emb 1, wherein the introducing the oxygen nanobubbles occurs directly into the metals laden water in a nanobubble generator positioned upstream of an oxidation chamber for the oxidizing.

Emb 4. The process of Emb. 1, further including introducing additional oxygen nanobubbles into the metals laden water from a recycled flow of the treated liquid stream.

Emb 5. The process of Emb 2, wherein the naturally occurring stream includes permafrost melt and other runoff having absorbed metals from soil, rock, abandoned mine sites, and other substrate.

Emb 6. The process of Emb. 1, further including introducing a caustic reagent into the metals laden water if a pH of the metals laden water is less than 7.0 pH.

Emb 7. The process of Emb 6, wherein the caustic reagent is selected from the group consisting of sodium hydroxide, calcium hydroxide, and other similar caustic reagents.

Emb 8. A process of recovering at least one type of metal from metals laden water, which includes: introducing nanobubbles into the metals laden water, wherein each nanobubble is a size in a range of from 1 nanometer to 900 nanometers; oxidizing the at least one metal in the metals laden water with the nanobubbles; and precipitating out the at least one metal from the metals laden water exposed to the nanobubbles.

Emb 9. The process of Emb 8, wherein the nanobubbles include a gas selected from the group consisting of oxygen nanobubbles, nitrogen nanobubbles, carbon dioxide nanobubbles, and mixtures thereof.

Emb 10. The process of Emb 8, wherein the metals laden water includes a stream selected from the group consisting of an acid-mine drainage stream, a process stream and wastewater stream generated from a mining and a metals refining operation, a process stream and wastewater generated from a metals recycling stream, another process stream or wastewater generated by an industrial process, a naturally occurring stream including permafrost melt and other runoff having metals absorbed therein from soil, rock, abandoned mine sites, and other substrate.

Emb 11. The process of Emb 8, further including introducing a caustic reagent into the metals laden water if a pH of the metals laden water is less than 7.0 pH.

Emb 12. The process of Emb 11, wherein the caustic reagent is selected form the group consisting of sodium hydroxide, calcium hydroxide, and similar caustic reagents.

Emb 13. The process of Emb 8, further including introducing additional nanobubbles into the metals laden water from a recycled flow of the metals laden water.

Emb 14. A process of dewatering metals recovered from a solution, which includes: mixing nanobubbles of gas into a metals laden solution, wherein each nanobubble of gas is a size in a range of from 1 nanometer to 900 nanometers for facilitating at least one of a precipitation rate of the metals out of the metals laden solution, and a filterability of the metals from the metals laden solution

Emb 15. The process of Emb 14, wherein the nanobubbles include a gas selected from the group consisting of oxygen nanobubbles, nitrogen nanobubbles, carbon dioxide nanobubbles, and mixtures thereof.

Emb 16. The process of Emb 14, wherein the metals laden solution comprises a stream selected from the group consisting of an acid-mine drainage stream, a process stream and wastewater stream generated from a mining and a metals refining operation, a process stream and wastewater generated from a metals recycling stream, another process stream or wastewater generated by an industrial process, a naturally occurring stream including permafrost melt and other runoff having metals absorbed therein from soil, rock, abandoned mine sites, and other substrate.

Emb 17. The process of Emb 14, further including introducing a caustic reagent into the metals laden solution if a pH of the metals laden water is less than 7.0 pH.

Emb 18. The process of Emb 14, wherein the caustic reagent is selected form the group consisting of sodium hydroxide, calcium hydroxide, and similar caustic reagents.

The present embodiments are directed as well to the use of nanobubbles of gas, particularly but not limited to oxygen, to facilitate recovery of dissolved metals and to improve the dewatering properties of the metals in industrial process streams and wastewaters as well as in naturally occurring metals laden waters. Other gases used for the nanobubbles may include nitrogen, carbon dioxide, and mixtures thereof.

The streams and wastewaters to be treated with the nanobubbles include but are not limited to acid-mine drainage stream, process streams and wastewaters generated from mining and metals refining operations, process streams and wastewaters generated from metals recycling streams and any other process stream, wastewater generated by an industrial process or naturally occurring stream in which metals are dissolved into water.

The present embodiments include generation or production of nanobubbles at a remote location outside of or external to the oxidation chamber and then injecting the nanobubbles into either the raw, untreated water or target stream (direct injection), or into a recycled stream of the treated water (indirect injection), or by both direct and indirect injection. In the present embodiments, the raw, untreated water or target stream may contain metals other than or in addition to iron, and while the nanobubbles are employed for oxidation, the process of introducing the nanobubbles is different from known methods and the media into which the nanobubbles are being deployed is different from known methods.

It will be understood that the embodiments described herein are merely exemplary, and that a person skilled in the art may make variations and modifications without departing from the spirit and scope of the invention. All such variations and modifications are intended to be included within the scope of the invention as provided for and claimed herein. It should be understood that the embodiments described above are not only in the alternative but can be combined.

What is claimed is:

1. A process of recovering at least one dissolved metal from metals laden water, comprising: introducing oxygen nanobubbles into the metals laden water, wherein each nanobubble is a size in a range of from 1 nanometer to 900 nanometers; oxidizing the at least one dissolved metal with the oxygen nanobubbles; and precipitating out oxidized metal from the metals laden water for recovering a treated liquid stream and metal particulate.

2. The process of claim 1, wherein the metals laden water is selected from the group consisting of an industrial process stream, an industrial wastewater stream, a naturally occurring stream, acid-mine drainage, wastewater generated from a mining and metals refining operation, a process stream and wastewater generated from a metals recycling process, and other process streams or wastewaters generated by an industrial process in which metals are dissolved into the process stream and the wastewater.

3. The process of claim 1, wherein the introducing the oxygen nanobubbles occurs directly into the metals laden water in a nanobubble generator positioned upstream of an oxidation chamber for the oxidizing.

4. The process of claim 1, further comprising introducing additional oxygen nanobubbles into the metals laden water from a recycled flow of the treated liquid stream.

5. The process of claim 2, wherein the naturally occurring stream comprises permafrost melt and other runoff having absorbed metals from soil, rock, abandoned mine sites, and other substrate.

6. The process of claim 1, further comprising introducing a caustic reagent into the metals laden water if a pH of the metals laden water is less than 7.0 pH.

7. The process of claim 6, wherein the caustic reagent is selected from the group consisting of sodium hydroxide, calcium hydroxide, and other similar caustic reagents.

8. A process of recovering at least one type of metal from metals laden water, comprising: introducing nanobubbles into the metals laden water, wherein each nanobubble is a size in a range of from 1 nanometer to 900 nanometers; oxidizing the at least one metal in the metals laden water with the nanobubbles; and precipitating out the at least one metal from the metals laden water exposed to the nanobubbles.

9. The process of claim 8, wherein the nanobubbles comprise a gas selected from the group consisting of oxygen nanobubbles, nitrogen nanobubbles, carbon dioxide nanobubbles, and mixtures thereof.

10. The process of claim 8, wherein the metals laden water comprises a stream selected from the group consisting of an acid-mine drainage stream, a process stream and wastewater stream generated from a mining and a metals refining operation, a process stream and wastewater generated from a metals recycling stream, another process stream or wastewater generated by an industrial process, a naturally occurring stream including permafrost melt and other runoff having metals absorbed therein from soil, rock, abandoned mine sites, and other substrate.

11. The process of claim 8, further comprising introducing a caustic reagent into the metals laden water if a pH of the metals laden water is less than 7.0 pH

12. The process of claim 11, wherein the caustic reagent is selected form the group consisting of sodium hydroxide, calcium hydroxide, and similar caustic reagents.

13. The process of claim 8, further comprising introducing additional nanobubbles into the metals laden water from a recycled flow of the metals laden water.

14. A process of dewatering metals recovered from a solution, comprising:
mixing nanobubbles of gas into a metals laden solution, wherein each nanobubble of gas is a size in a range of from 1 nanometer to 900 nanometers for facilitating at least one of a precipitation rate of the metals out of the metals laden solution, and a filterability of the metals from the metals laden solution.

15. The process of claim 14, wherein the nanobubbles comprise a gas selected from the group consisting of oxygen nanobubbles, nitrogen nanobubbles, carbon dioxide nanobubbles, and mixtures thereof.

16. The process of claim 14, wherein the metals laden solution comprises a stream selected from the group consisting of an acid-mine drainage stream, a process stream and wastewater stream generated from a mining and a metals refining operation, a process stream and wastewater generated from a metals recycling stream, another process stream or wastewater generated by an industrial process, a naturally occurring stream including permafrost melt and other runoff having metals absorbed therein from soil, rock, abandoned mine sites, and other substrate.

17. The process of claim 14, further comprising introducing a caustic reagent into the metals laden solution if a pH of the metals laden water is less than 7.0 pH.

18. The process of claim 14, wherein the caustic reagent is selected form the group consisting of sodium hydroxide, calcium hydroxide, and similar caustic reagents.
